(19) United States
(12) Patent Application Publication
(10) Pub. No.: US 2018/0218118 A1
(43) Pub. Date: Aug. 2, 2018

(54) METHODS AND SYSTEMS FOR MUTATION VISUALIZATION

(71) Applicant: St. Jude Children's Research Hospital, Memphis, TN (US)

(72) Inventors: Xin Zhou, Memphis, TN (US); Jinghui Zhang, Memphis, TN (US)

(21) Appl. No.: 15/742,622

(22) PCT Filed: Jul. 6, 2016
(86) PCT No.: PCT/US2016/041124

§ 371 Date: Jan. 8, 2018

Related U.S. Application Data
(60) Provisional application No. 62/189,023, filed on Jul. 6, 2015.

(51) Int. Cl. G06F 19/26; G06F 19/22

(52) U.S. Cl. CPC G06F 19/26; G06F 19/22

(57) ABSTRACT

Methods and systems for visually representing genomic mutations are disclosed. An example method can comprise receiving, at a computer, mutation information regarding one or more mutations of a protein. The computer can determine one or more mutations in the amino acid sequence, and can sort the one or more mutations according to a position of the one or more mutations in the amino acid sequence. For each of the one or more mutations, one or more mutation characteristics are determined and a display position can be set. The display position can comprise a horizontal position and a vertical position. A graphical representation of all of the one or more mutations is displayed. All of the one or more mutations are arranged based on the selected display positions, and an alignment position marker connects the display position to a marker indicating the position of the mutated amino acid.

### CROSS REFERENCE TO RELATED PATENT APPLICATION

This application claims priority to U.S. Provisional Application No. 62/189,023 filed Jul. 6, 2015, herein incorporated by reference in its entirety.

### BACKGROUND

Visual representations of occurrences of genomic mutations over the amino acid sequence of a protein are a useful tool for medical research. In particular, tools that allow for visualization of mutation can aid in explorative data analysis, such as determining whether or not a particular gene is altered in a specific cancer type, how frequently a particular trait (e.g., epidermal growth factor receptor (EGFR)) is overexpressed in a particular cancerous growth (e.g., glioblastoma), and whether or not mutations of two particular genes (e.g., BRCA1 and BRCA2) co-occur in particular cancers (e.g., ovarian cancer)).

However, existing visualization tools are incomplete. Traditional visualization tools provide a view of all mutations in a protein, but only provide a text label for the most abundant mutation(s). Without labeling, display of other mutations is less useful. Further, because traditional visualization tools position mutation markers linearly based on an abundance of mutations at that particular amino acid, it is difficult for users to select a particular mutation from a group of proximate mutations having similar abundance. These and other issues are addressed in the present disclosure.

### SUMMARY

It is to be understood that both the following general description and the following detailed description are exemplary and explanatory only and are not restrictive. Provided are methods and systems for visually representing genomic mutations.

In an aspect, a computer can receive mutation data regarding one or more mutations of a protein. The computer can sort the one or more mutations present in the mutation data according to a position of the one or more mutations in an amino acid sequence. For one or more (e.g., each) of the one or more mutations, one or more mutation characteristics can be determined and a display position can be set. The display position can include a horizontal position and a vertical position. A graphical representation of all of the one or more mutations can be displayed. All of the one or more mutations can be arranged based on the selected display positions, and an alignment position marker can connect the display position to a marker indicating the position of the mutated amino acid.

In another aspect, a computer can receive amino acid sequence data indicating an amino acid sequence of a protein. The amino acid sequence data can comprise a plurality of data points. For each of the plurality of data points, a display position can be set. A horizontal component of the display position can be set based on an expression value, and the plurality of data points can be arranged vertically in order of expression values. The received amino acid sequence data can be displayed based on the set display positions.

In still another aspect, a computer can receive amino acid sequence data indicating an amino acid sequence of a protein and mutation data regarding one or more mutations. The one or more mutations can be sorted according to a position of the one or more mutations in the amino acid sequence. The computer can display a protein bar representing the protein along a first axis, and can display the received amino acid sequence data graphically along the protein bar as one or more graphical representations. The computer can receive an indication from a user and can adjust one or more display characteristics in response to the indication.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a flowchart illustrating an example method;

FIG. 2A illustrates a first graphical representation of a mutation;

FIG. 2B illustrates a second graphical representation of a mutation;

FIG. 3A illustrates a third graphical representation of a mutation;

FIG. 3B illustrates a fourth graphical representation of a mutation;

FIG. 4A illustrates a fifth graphical representation of a truncation mutation;

FIG. 4B illustrates a fifth graphical representation of another truncation mutation;

FIG. 5 illustrates a collapsed graphical representation of a mutation;

FIG. 6 is a flowchart illustrating an example method;

FIG. 7 illustrates an example graph;

FIG. 8 illustrates an example chart;

FIG. 9 is a flowchart illustrating an example method;

FIG. 10A shows mutation information using the first graphical representation.

FIG. 10B shows mutation information using the collapsed graphical representation;

FIG. 11A shows mutation information before a zoom function is applied;

FIG. 11B shows mutation information after a zoom function is applied;

FIG. 12 illustrates an enhanced view of a portion of a protein bar; and

FIG. 13 is a block diagram of an exemplary computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for visualization of mutations. In particular, genomic mutation of an amino acid sequence forming a protein can be visualized, showing the areas of the protein that have higher incidence of mutation, and/or showing mutation commonalities across a plurality of subjects. The visualization methods and systems highlight critical mutation attributes, including a form of protein variant (e.g., a new amino acid formed as a result of a missense mutation), a sample name from which a mutation was identified, whether the mutation is somatic or germline in a particular sample, whether the mutation appears during a relapse phase of treatment, and/or whether the mutation results in a fusion gene (e.g., as a result of translocation, interstitial deletion, or chromosomal inversion). The methods and systems further allow for display of mutations at a nucleotide resolution. Moreover, the methods and systems allow for the visualization to retain legibility when showing a large amount of data. Mutational profiles for the same protein can be shown across multiple data sets, allowing for cross-project comparison.

The methods and systems produce visualizations that show all mutation variants at the same mutation position, and shift labels to avoid overlap, improving legibility. The visualizations also allow for a reduced-information view that provides a mutational landscape of a protein, showing where mutations tend to form, The visualization tools allow a user to zoom in on areas of particular interest, and enable panning to find desired information. The systems and methods can also show relevant gene expression data alongside mutation data to enhance correlations.

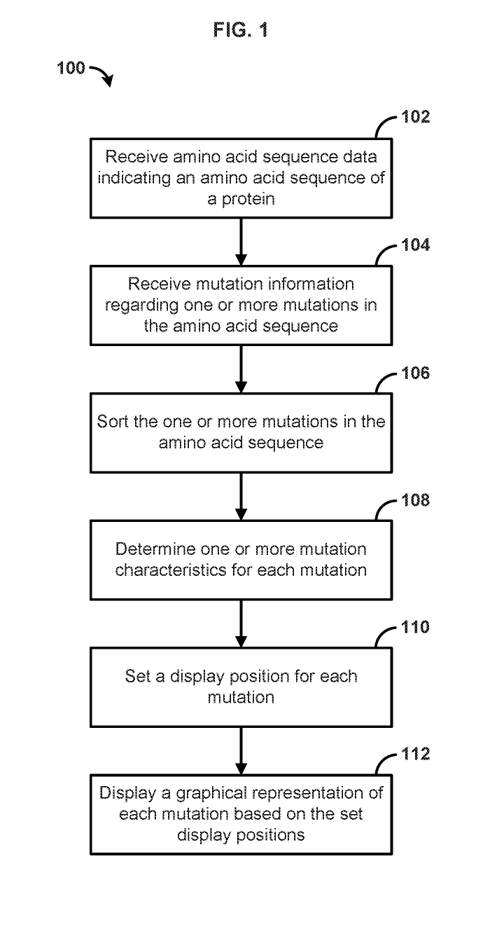

FIG. 1 is a flowchart showing example method 100. At step 102, a computer can receive amino acid sequence data indicating an amino acid sequence of a gene or protein. In an aspect, the amino acid sequence data can be retrieved from a server. In an aspect, the amino acid sequence data can comprise a plurality of amino acid sequences for the same protein. In an aspect, each of the plurality of amino acid sequences can comprise an amino acid sequence which makes up a specific protein from a particular subject, such that each of the plurality of amino acid sequences corresponds to a distinct subject. In an aspect, the retrieved amino acid sequence data can be limited to a particular number of base pairs to be considered. For example, the retrieved sequence size can be selected based on a number of base pairs present in a particular gene or protein. As a particular example, the retrieved sequence size can be limited to about two million base pairs.

At step 104, the computer can retrieve mutation information regarding one or more mutations in the amino acid sequence. In an aspect, each mutation can comprise a genomic mutation. In an aspect, the mutation information can comprise information regarding one or more mutations related to a gene or protein (e.g., the gene or protein represented by the amino acid sequence data retrieved in step 102). In an aspect, the mutation information can be provided by a server. For example, the server used to provide the amino acid sequence data in step 102 can also provide the mutation information. In another aspect, the mutation information can be provided by an end user directly. In yet another aspect, the mutation information can be provided from one or more third-party tools used to discover the mutations.

At step 106, the one or more mutations can be sorted according to a position of the one or more mutations in the amino acid sequence. For example, each amino acid in a reference sequence that forms a protein can be numbered consecutively, and each of the one or more mutations determined to exist in the amino acid sequence data can be numbered according to the amino acid in the sequence that forms the protein.

At step 108, the computer can determine one or more mutation characteristics for each of the one or more mutations. In an aspect the one or more mutation characteristics comprise a mutation class, an indicator of an original amino acid, an indicator of the position of the mutated amino acid, an indicator of a mutation variant, a mutation count, an indication of whether the mutation is a germline mutation, and an indication of whether the mutation is a relapse mutation, and/or a combination thereof. In another aspect, the one or more mutation characteristics can further comprise an indicator of whether the mutation results in a fusion gene.

As non-limiting examples, a mutation class can comprise a point mutation such as a silent, missense, or nonsense mutation, an insertion mutation such as a frameshift, a deletion mutation, and/or a splice site mutation. The indicator of the original amino acid can indicate the amino acid in the reference sequence. The indicator of the mutation variant can indicate new amino acid(s) formed by the mutation. The indicator of the position of the amino acid can indicate the position of the mutation relative to the first amino acid in the reference sequence. The mutation count can indicate a number of mutations of the same variant at the same position present in the mutation information (e.g., within a set of cancer samples or a human subject cohort). As an example, the mutation count can be shown as an absolute quantity. In an aspect, the germline indicator can indicate a presence and a percentage of germline mutations in a group of mutations. In another aspect, the relapse indicator can indicate the presence and percentage of relapse mutations in a group of mutations. In an aspect, a relapse mutation can comprise a somatic variant found in a relapse sample in which cancer has returned after being cured for a period. The indicator of whether or not the mutation results in a fusion gene can indicate whether the mutation is of a type (e.g., translocation, interstitial deletion, or chromosomal inversion, etc.) that results in a fusion gene (e.g., a hybrid gene formed from two previously separate genes).

At step 110, a display position is set for each of the one or more mutations. The display position comprises a horizontal position and a vertical position. In an aspect, the horizontal direction generally indicates a position on the protein, and a vertical position generally indicates an abundance of the mutation. In an aspect, the horizontal position can be selected based on the position of the mutated amino acid in the amino acid sequence and/or a presence of mutations proximate to the position of the mutated amino acid. That is, the horizontal position can first be selected based on the position of the mutated amino acid in the amino acid sequence. The horizontal position can be shifted based on other mutations proximate in horizontal position. As an example, the position can be shifted horizontally such that there is no overlap between labeling for the mutated amino acid and labels for one or more adjacent mutated amino acids. The vertical position of each variant of the mutated amino acid can be selected based on an abundance of the variant at the position of the mutated amino acid. For example, the vertical position of each of the mutation variants at a particular horizontal position can be adjusted such that mutation variants having higher abundance are lower (e.g., nearer to the protein bar).

At step 112 a graphical representation of all of the one or more mutations can be displayed. All of the one or more mutations can be arranged based on the selected display positions. In an aspect, an alignment position marker can connect the display position to a marker indicating the position of the mutated amino acid.

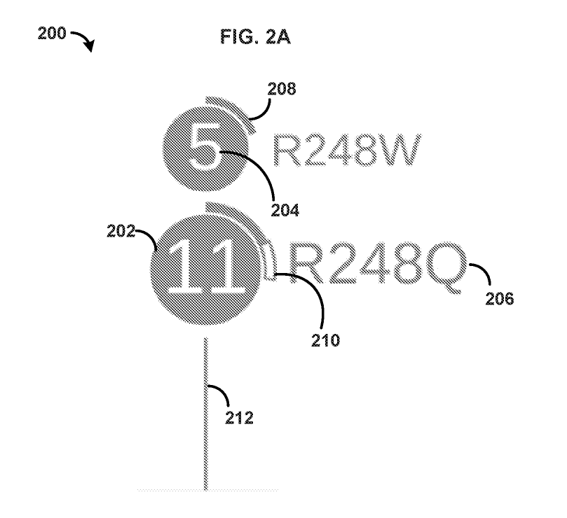

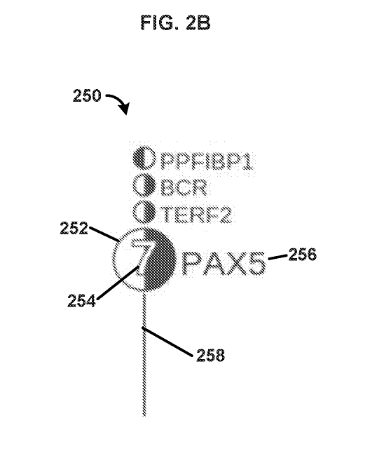

An example first graphical representation 200 is shown in FIG. 2A. In an aspect, the first graphical representation 200 can represent a location of a mutation at a particular amino acid. For example, the representation can represent single nucleotide variation (SNV) and/or insertion/deletion (indel) mutations. In an aspect, one or more mutation variants can be represented by separate discs 202. In an aspect, each disc 202 can have a size based on an abundance of the mutation variant. For example, a radius of the disc 202 can be increased according to the abundance of the mutation variant. In an aspect at least a portion of each disc 202 can be colored to indicate a particular mutation class associated with the mutation variant. Each disc 202 can comprise an indicator 204 showing the abundance of the variant. Each disc 202 can further comprise a label 206.

The label 206 can comprise one or more of an indication of the original amino acid in the reference amino acid sequence, an amino acid position relative to the first amino acid in the sequence, and an indication of the variant. In an aspect, the indication of the original amino acid and the indication of the variant can use the International Union of Pure and Applied Chemistry (IUPAC) codes to indicate corresponding amino acids. As an example, FIG. 2A shows a label 206 that reads “R248Q.” In this label, “R” indicates that the original amino acid is Arginine, “248” indicates that the position of the mutation is at amino acid number 248, and “Q” indicates that the mutation variant is Glutamine.

Each disc 202 can further comprise a first arc 208 and a second arc 210. The first arc 208 can be an indicator of germline mutation. In an aspect, the first arc 208 can at least partially surround the disc 202, beginning at a twelve o'clock position. In an aspect, a length of the first arc 208 can correspond to a percentage of mutations that are germline mutations. In an aspect, the second arc 210 can be an indicator of a relapse mutation. In an aspect, the second arc 210 can at least partially surround the disc 202, beginning at a terminal point of the first arc 208. In an aspect, a length of the second arc 210 can correspond to a percentage of mutations that are relapse mutations.

The first graphical representation 200 can further comprise a disc alignment indicator 212. In an aspect, the disc alignment indicator 212 can be used to indicate a position on the protein bar corresponding to the mutated amino acid. In an aspect, the disc alignment indicator can be a straight line. Alternatively, the disc alignment indicator 212 can be bent to show a horizontal shift based on a proximity of additional graphical representations 200.

In an aspect, one or more mutations can be selected for display using corresponding first graphical representations 200. For example, selected mutations can have an abundance exceeding a predetermined threshold, a particular number of mutations having the highest abundance among all mutations in the amino acid sequence, or the like.

A second graphical representation 250 is shown in FIG. 2B. In an aspect, the second graphical representation 250 can be used to represent fusion mutations. The second graphical representation 250 can comprise one or more discs 252. In an aspect, the one or more discs 252 can represent different fusion partners. The one or more discs 252 can have a size based on a number of occurrences of the fusion mutation in the mutation information (e.g., a study cohort). For example, the disc radius can vary based on the number of occurrences of the fusion mutation in the mutation information (e.g., a study cohort). Further, one or more discs 252 can comprise a label showing an abundance of a fusion mutation using the fusion partner. In an aspect, each disc 252 can also comprise indicia of how a gene is fused with its fusion partner. As an example, where there are two possible fusion locations, the indicia can comprise dividing one or more of the discs 252 into two sections (e.g., dividing the discs 252 in half) and coloring a first section of the disc 252 to correspond to a first of the fusion locations or coloring a second section of the disc 252 to correspond to a second of the fusion locations. Each disc 252 can comprise an indicator 254 showing the abundance of the variant. In an aspect, the second graphical representation 250 can further comprise an indicator 256 indicating a fusion partner name.

The second graphical representation 250 can further comprise a disc alignment indicator 258. In an aspect, the disc alignment indicator 258 can be used to indicate a position on the protein bar corresponding to a fusion mutation. In an aspect, the disc alignment indicator 258 can be formed as a straight line. Alternatively, the disc alignment indicator 258 can be bent to show a horizontal shift based on proximity of additional graphical representations 250.

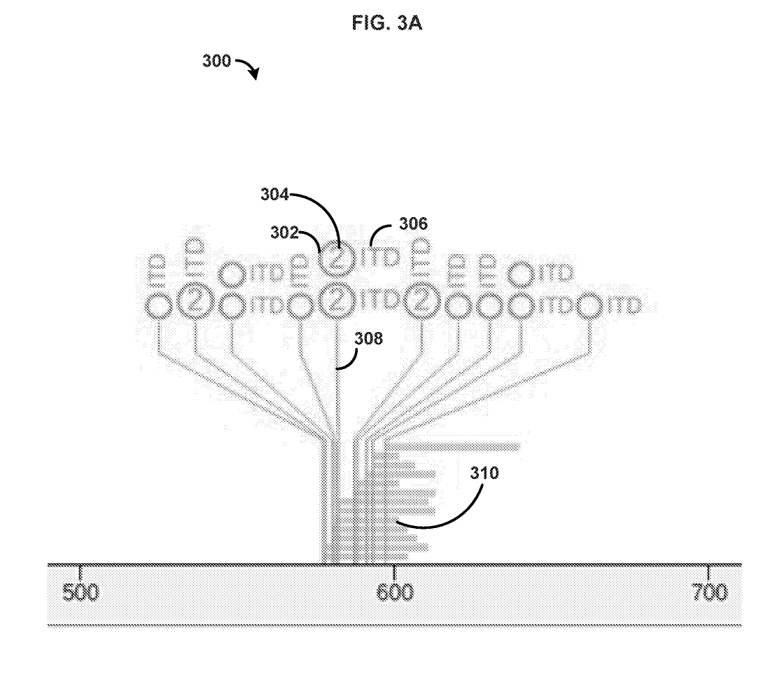

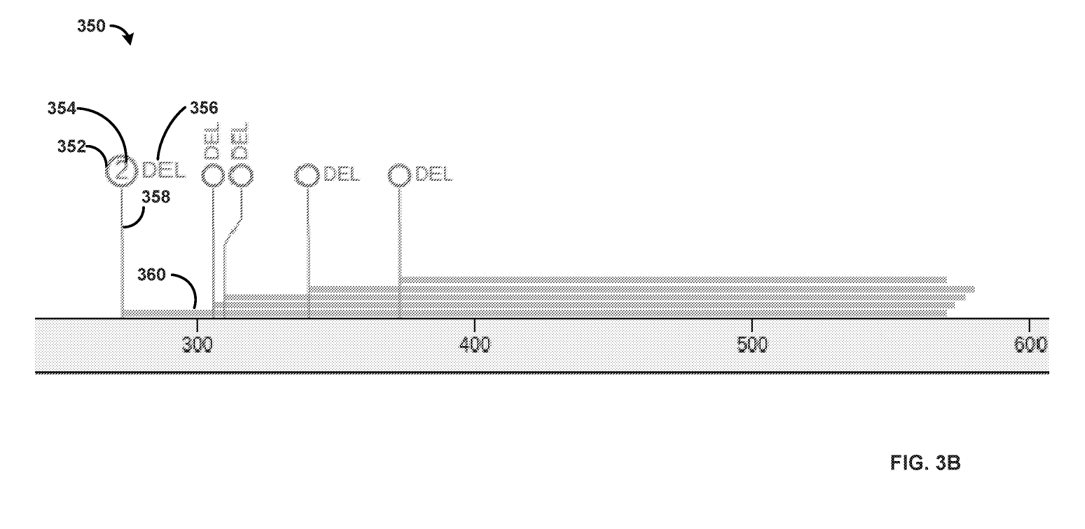

A third graphical representation 300 is shown in FIG. 3A. In an aspect, the third graphical representation 300 can represent a location of an internal tandem duplication (ITD) mutation of a protein. An ITD mutation can comprise duplication of one or more amino acids within a protein. In some aspects, ITD mutations can be important because the mutations can be a hallmark of leukemia. In an aspect, one or more mutation variants can be represented by separate discs 302. In an aspect, each disc 302 can have a size based on an abundance of the mutation For example, a radius of the disc 302 can be increased according to the abundance of the mutation variant. In an aspect at least a portion of each disc 302 can be colored to indicate a particular mutation class associated with the mutation variant. For example, an outline of the disc can be colored to indicate the ITD mutation. Each disc 302 can comprise an indicator 304 showing the abundance of the variant. Each disc 302 can further comprise a label 306. The label 306 can indicate the type of mutation. For example, the label 306 can be “ITD”, indicating that the representation 300 represents an ITD mutation.

The third graphical representation 300 can further comprise a disc alignment indicator 308. In an aspect, the disc alignment indicator 308 can be used to indicate a position on the protein bar corresponding to the location of the ITD mutation. In an aspect, the disc alignment indicator 308 can be a straight line. Alternatively, the disc alignment indicator 308 can be bent to show a horizontal shift based on a proximity of additional graphical representations (e.g., representations 200, 250, 300, etc.).

The third graphical representation 300 can further comprise a duplication extent indicator 310. The duplication extent indicator 310 can extend horizontally from the alignment indicator 308. In some aspects, a length of the duplication extent indicator 310 can be proportional to a number of amino acids duplicated in the protein.

A fourth graphical representation 350 is shown in FIG. 3B. In an aspect, the fourth graphical representation 350 can represent a location of an internal deletion mutation of a protein. An internal deletion mutation can comprise deletion of one or more amino acids within a protein. In some aspects, deletion of one or more amino acids from a protein can disrupt the normal function of the protein. Such deletions can cause, or contribute to causing one or more cancers. In an aspect, an internal deletion mutation can be represented by a discs 352. In an aspect, each disc 352 can have a size based on an abundance of the mutation For example, a radius of the disc 352 can be increased according to the abundance of the mutation variant. In an aspect at least a portion of each disc 352 can be colored based on the mutation type. For example, an outline of the disc can be colored to indicate the internal deletion mutation. Each disc 352 can comprise an indicator 354 showing the abundance of the variant. Each disc 352 can further comprise a label 356. The label 356 can indicate the type of mutation. For example, the label 356 can be “DEL”, indicating that the representation 350 represents an internal deletion mutation.

The fourth graphical representation 350 can further comprise a disc alignment indicator 358. In an aspect, the disc alignment indicator 358 can be used to indicate a position on the protein bar corresponding to the location of the internal deletion mutation. In an aspect, the disc alignment indicator 358 can be a straight line. Alternatively, the disc alignment indicator 358 can be bent to show a horizontal shift based on a proximity of additional graphical representations (e.g., representations 200, 250, 300, 350, etc.).

The fourth graphical representation 350 can further comprise a deletion extent indicator 360. The deletion extent indicator 360 can extend horizontally from the alignment indicator 358. In some aspects, a length of the deletion extent indicator 360 can be proportional to a number of amino acids deleted from the protein.

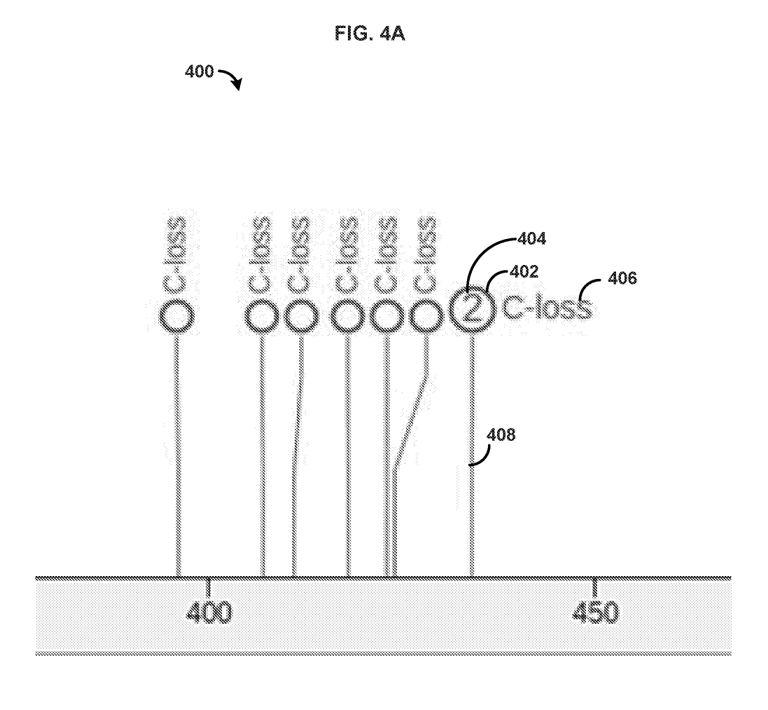

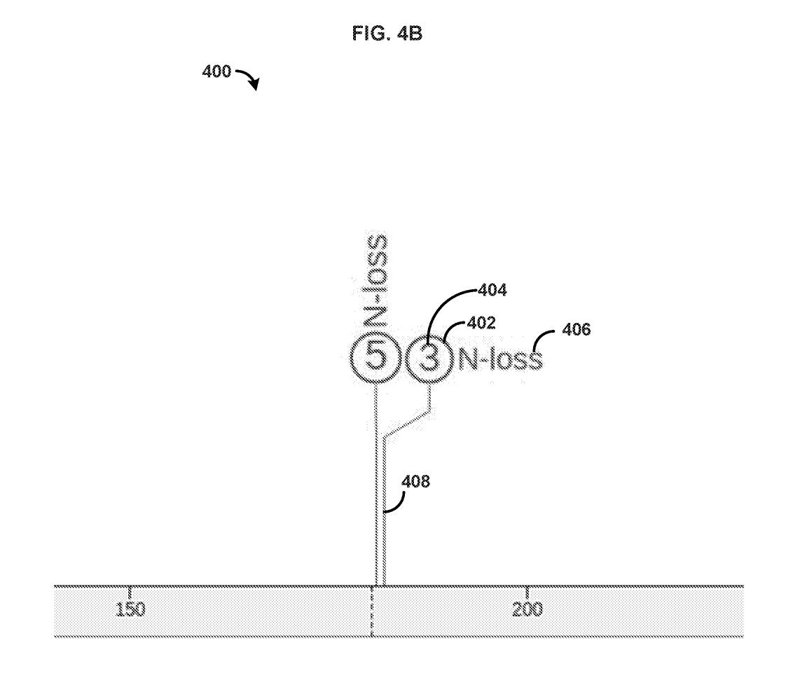

A fifth graphical representation 400 is shown in FIGS. 4A and 4B. In an aspect, the fifth graphical representation 400 can represent a location of a truncation mutation. In some aspects, truncation mutations can be early termination of a protein, such that all amino acids that comprise a protein subsequent to the truncation point are absent from the truncated protein (e.g., a C-loss truncation) or late commencement of a protein, such that all amino acids that comprise a protein prior to a truncation point are absent from the truncated protein (e.g., an N-loss truncation). In some aspects, truncation of a protein can disrupt a normal function of the protein and can be a cause of certain cancer.

In an aspect, a truncation mutation can be represented by a disc 402. In an aspect, each disc 402 can have a size based on an abundance of the mutation For example, a radius of the disc 402 can be increased according to the abundance of the mutation variant. In an aspect at least a portion of each disc 402 can be colored to indicate a particular mutation class associated with the mutation variant. For example, an outline of the disc can be colored to indicate the truncation mutation. In some aspects, all truncation mutations can be colored similarly. In other aspects, C-loss mutations and N-loss mutations can be colored differently. Each disc 402 can comprise an indicator 404 showing the abundance of the variant. Each disc 402 can further comprise a label 406. The label 406 can indicate the type of mutation. As an example, as shown in FIG. 4A, the label 406 can be “C-loss”, indicating that the representation 400 represents a C-loss type truncation mutation. As another example, as shown in FIG. 4B, the label 406 can be “N-loss”, indicating that the representation 400 represents an N-loss type truncation mutation.

The fifth graphical representation 400 can further comprise a disc alignment indicator 408. In an aspect, the disc alignment indicator 408 can be used to indicate a position on the protein bar corresponding to the location of the truncation mutation (e.g., the last protein present in a C-loss type truncation mutation or the first protein present in an N-loss type truncation mutation). In an aspect, the disc alignment indicator 408 can be a straight line. Alternatively, the disc alignment indicator 408 can be bent to show a horizontal shift based on a proximity of additional graphical representations (e.g., representations 200, 250, 300, 350, 400, etc.).

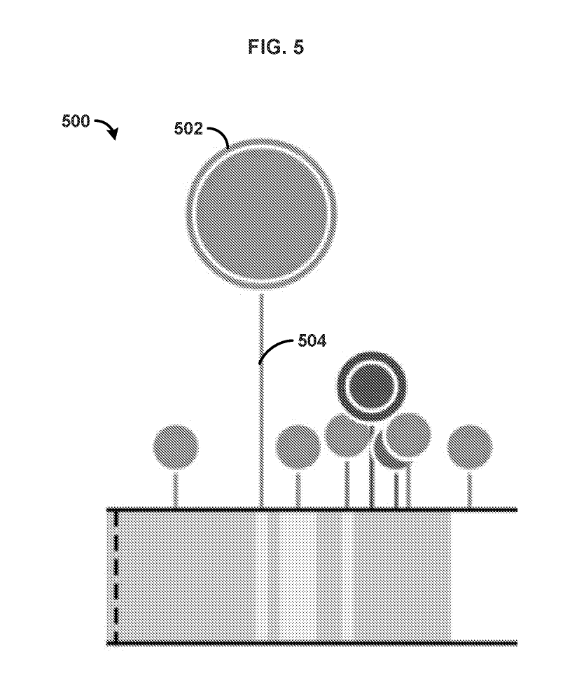

FIG. 5 shows an example collapsed graphical representation 500. In an aspect, each mutation variant can be represented by a disc 502. In an aspect, each disc 502 can have a size based on an abundance of the mutation variant (e.g., a mutation count of the mutation variant). For example, a radius of the disc 502 can be increased according to the abundance of the mutation variant. In an aspect at least a portion of each disc 502 can be colored to indicate a particular mutation class associated with the mutation variant.

In an aspect, each disc 502 can be arranged according to a location of the mutation within a protein or gene, such that discs 502 corresponding to different mutations occurring at the same location in the protein or gene are disposed concentrically. The discs 502 can be arranged by size, such that smaller discs 502 are in the foreground and larger discs 502 are in the background. The collapsed graphical representation 500 can further comprise a disc alignment indicator 504. In an aspect, the disc alignment indicator 504 can be used to indicate a position on the protein bar corresponding to the mutated amino acid. In an aspect, the disc alignment indicator 504 can be a straight line. A length of the disc alignment indicator 504 can be selected based on a sum of abundances of the mutation variants at a given position.

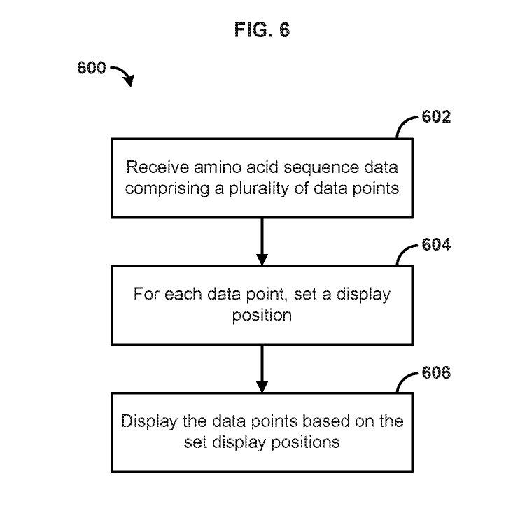

FIG. 6 is a flowchart showing example method 600. At step 602, a computer can receive amino acid sequence data comprising a plurality of data points. As an example, the amino acid sequence data can indicate an amino acid sequence of a protein or gene. In an aspect, each of the plurality of data points can be related to expression (e.g., gene expression). For example, each of the data points can comprise an expression value. In an aspect, expression can indicate transcript abundance of each data point, measured according to normalized sequencing read count form a ribonucleic acid (RNA) sequencing experiment using a sample. Each of the data points can be related to mutation data. As an example, the data points can come from a set of samples used to gather mutation data. The amino acid sequence data can further comprise metadata indicating sample groups.

At step 604 a display position can be set for each of the plurality of data points. The display position can comprise a horizontal component and a vertical component. In an aspect, the horizontal component of the display position is set based on an expression value. For example, the expression value can be measured in Fragments Per Kilobase of transcript per Million mapped reads (FPKM), Reads Per Kilobase of transcript per Million mapped reads (RPKM), or the like. The vertical component of the display position is also determined based on the expression value. For example, the plurality of data points can be arranged vertically in order of corresponding expression values.

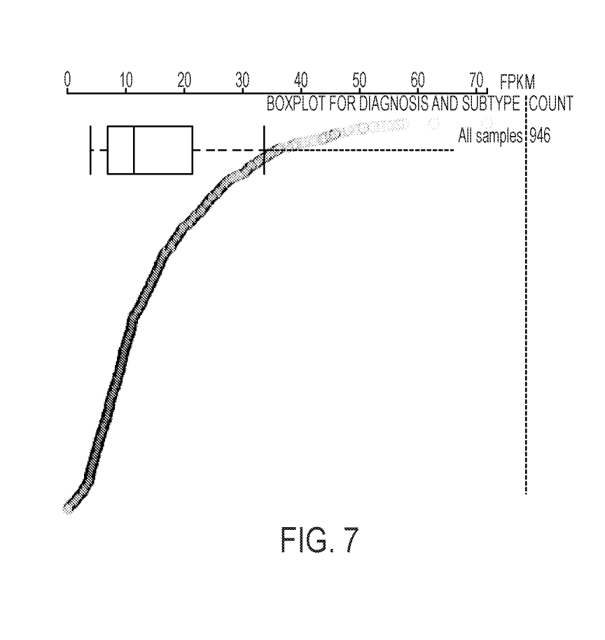

In step 606, the plurality of data points of the received amino acid sequence data can be displayed based on the set display positions. In an aspect, the display can comprise a horizontal expression value axis showing the expression values. In an aspect, the vertical axis can be dimensionless. FIG. 7 shows an example of the displayed data points.

In an aspect, a first boxplot can also be displayed. As shown in FIG. 7, the first boxplot can indicate first quartile, second quartile (e.g., median), and third quartile values of the plurality of data points. In an aspect, the boxplot can also comprise whiskers indicating the ninth and ninety first percentiles. In an aspect, one or more additional boxplots can be displayed. The one or more additional boxplots can be created based on, for example the sample groups indicated in the metadata of the amino acid sequence data, a subset of the plurality of data points indicated by a user, or the like.

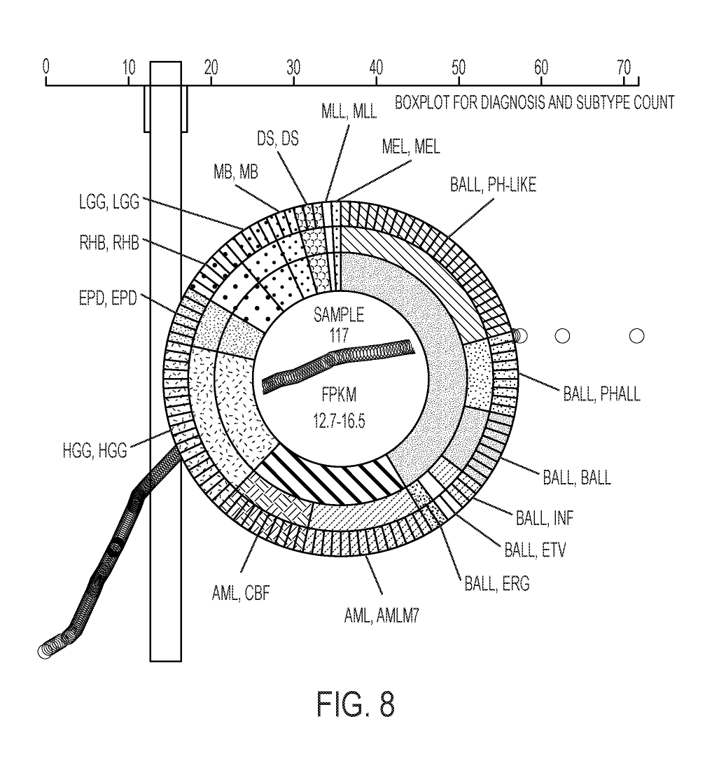

In an aspect, a user can select a range of expression values. For example, the user can use a computer mouse to select a range of values along the expression value axis. In response to the user selection, a hierarchical chart can be displayed showing group and subgroup compositions. In an aspect, the groups can be defined based on a cancer type (e.g., carcinoma, sarcoma, lymphoma, blastoma, etc.), and the subgroups can be defined based on a cancer subgroup. An example hierarchical chart is shown in FIG. 8.

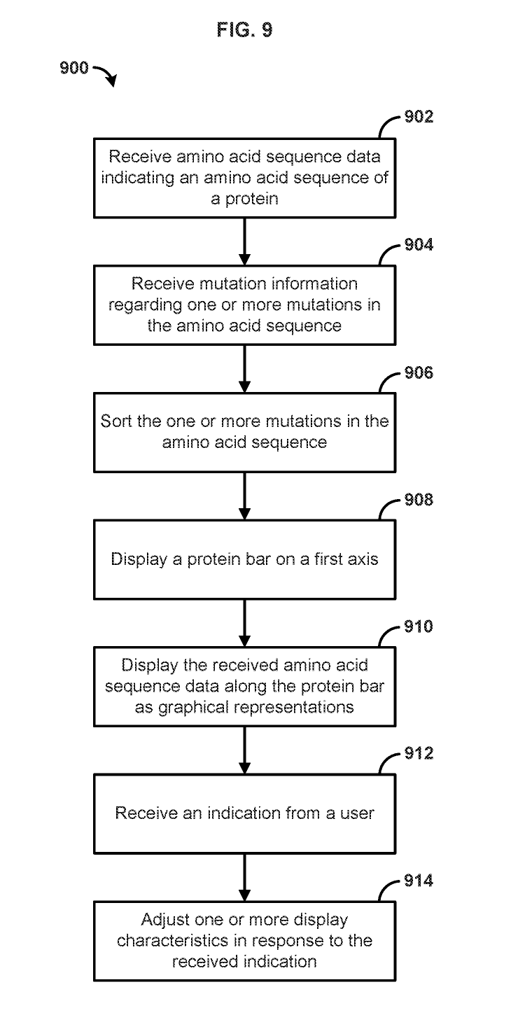

FIG. 9 is a flowchart showing another example method 900. At step 902, a computer can receive amino acid sequence data indicating an amino acid sequence of a protein. In an aspect, the amino acid sequence data can be retrieved from a server. In an aspect, the amino acid sequence data can comprise a plurality of amino acid sequences for the same protein. In an aspect, each of the plurality of amino acid sequences can comprise an amino acid sequence which makes up a specific protein from a particular subject, such that each of the plurality of amino acid sequences corresponds to a distinct subject. In an aspect, the retrieved amino acid sequence data can be limited to a particular number of base pairs to be considered. For example, the retrieved sequence size can be selected based on a number of base pairs present in a particular gene or protein. As a particular example, the retrieved sequence size can be limited to about two million base pairs.

At step 904, the computer can receive mutation data regarding one or more mutations in the amino acid sequence. In an aspect, each mutation can comprise a genomic mutation. In an aspect, the mutation information can comprise information regarding one or more mutations related to a gene or protein (e.g., the gene or protein represented by the amino acid sequence data retrieved in step 902). In an aspect, the mutation information can be provided by a server. For example, the server used to provide the amino acid sequence data in step 902 can also provide the mutation information. In another aspect, the mutation information can be provided by an end user directly. In yet another aspect, the mutation information can be provided from one or more third-party tools used to discover the mutations.

At step 906, the one or more mutations can be sorted. For example, the mutations can be sorted according to a position of the one or more mutations in the amino acid sequence. For example, each amino acid in a reference sequence that forms a protein can be numbered consecutively, and each of the one or more mutations determined to exist in the amino acid sequence data can be numbered according to the amino acid in the sequence that forms the protein.

At step 908, a protein bar can be displayed along a first axis. In an aspect, the protein bar can be displayed along the horizontal axis. The protein bar can be a bar indicating a relative position of the one or more mutations in the protein.in an aspect a length of the protein bar corresponds to the overall length of the protein in the amino acid sequence data.

At step 910, the received amino acid sequence data can be displayed graphically along the protein bar as one or more graphical representations. For example, each mutation can be displayed as one of a first graphical representation 200, a second graphical representation 250, a third graphical representation 300, a fourth graphical representation 350, a fifth graphical representation 400, or a collapsed graphical representation 500. In an aspect, one or more mutations having the highest abundance among the mutations are displayed using the first graphical representation 200, the second graphical representation 250, the third graphical representation 300, the fourth graphical representation 350, or the fifth graphical representation 400, while others of the one or more mutations are displayed using the collapsed graphical representation 500. In an alternative embodiment, mutations having an abundance that exceeds a predetermined threshold are displayed using the first graphical representation 200, the second graphical representation 250, the third graphical representation 300, the fourth graphical representation 350, or the fifth graphical representation 400, while others of the one or more mutations are displayed using the collapsed graphical representation 500.

At step 912, an indication can be received from a user. The indication can be a user input to a computer via an interface such as a mouse, trackball, touchpad, or the like. At step 914, in response to the user input, one or more display characteristics can be adjusted.

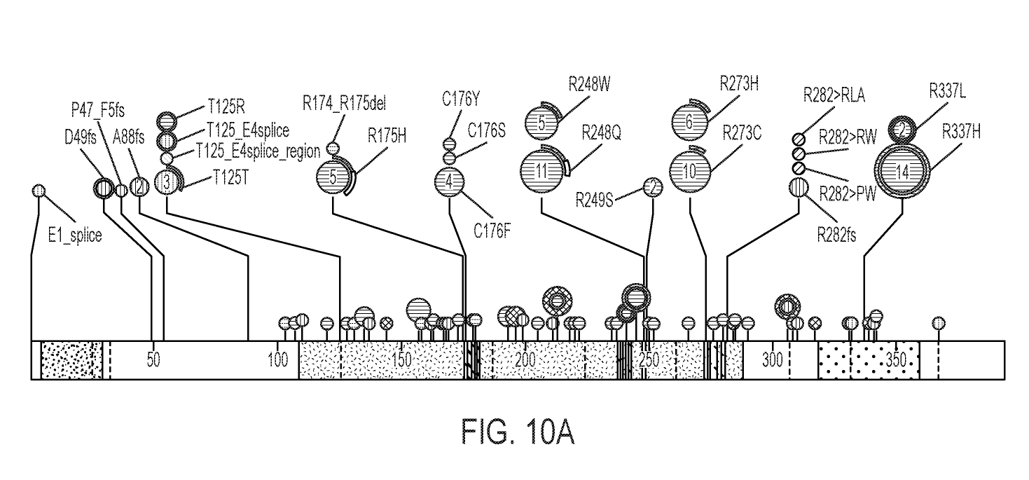

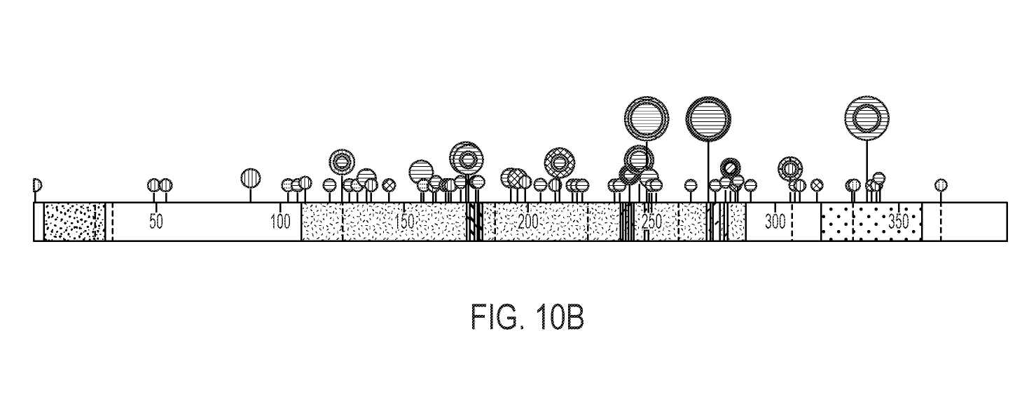

In an aspect, the indication received via user input at step 912 can comprise selection of one of the one or more graphical representations 200, 250, 300, 350, 400 (e.g., a particular graphical representation). In response, to the selection, the graphical representation can be adjusted between the particular graphical representation and the collapsed graphical representation. For example, if the user selects a mutation displayed as a first graphical representation 200, the display will be adjusted such that the mutation is displayed as a collapsed graphical representation 500. Conversely, if the user selects a mutation displayed as a collapsed graphical representation 500, the display will be adjusted such that the mutation is displayed as a first graphical representation 200. As an example, FIG. 10A shows mutation information displayed as the first graphical representation 200, FIG. 10B shows the same mutation information displayed as the second graphical representation 500.

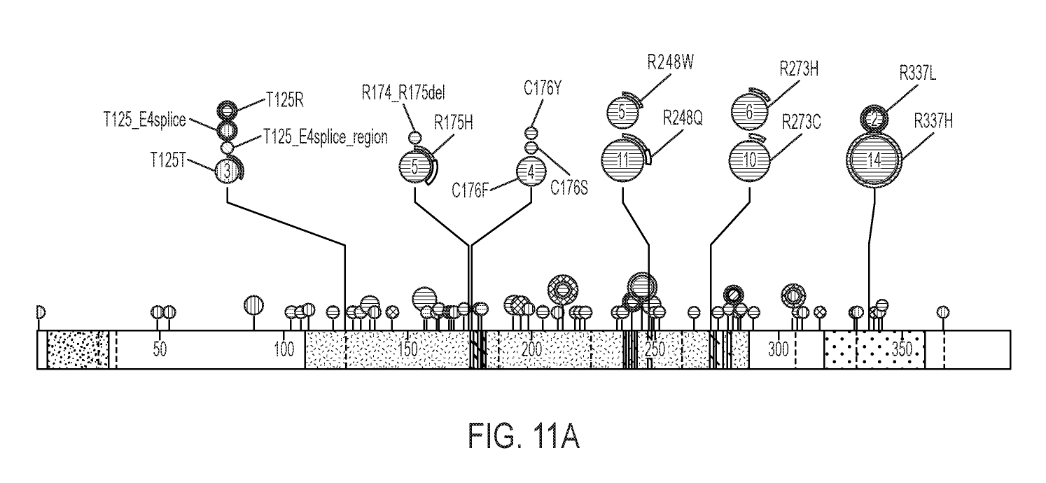

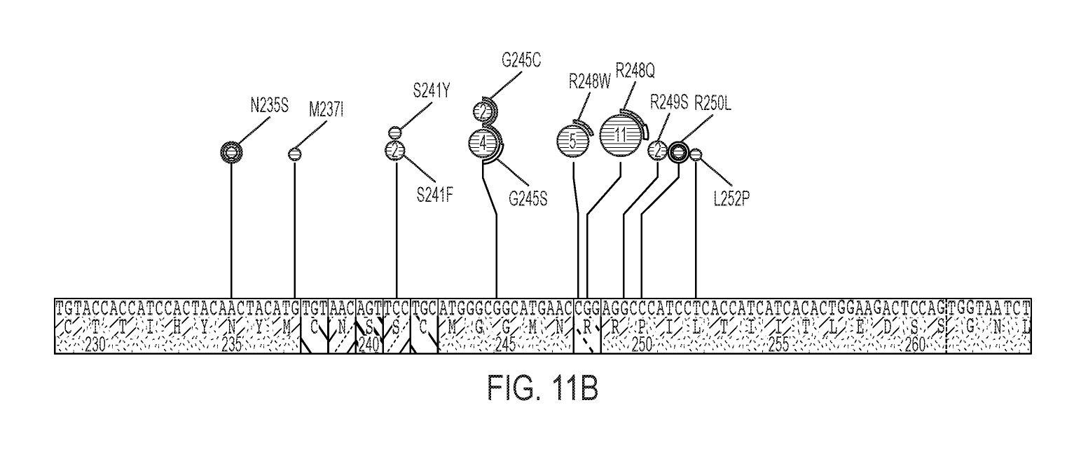

In an aspect, the indication received via user input at step 912 can comprise a selection of a portion of the protein bar. As a particular, example, FIG. 11A shows an example representation, including a portion of the protein bar numbered from about 0 to about 400. In response to a user indication, the display can be adjusted to comprise the selected portion of the protein bar. For example, the display can be adjusted to comprise only the selected portion of the protein bar. As a particular example, in response to a user selection of a portion of the protein bar in FIG. 11A between about 230 and about 260, the display can be adjusted as shown in FIG. 11B to show the selected portion of the protein bar. In an aspect, further indication can be received from the user indicating that the user wishes to revert to the original display showing the full protein bar. In response to the further indication, the display characteristics can revert to the original characteristics. In another aspect, the further indication can be a selection of a particular point on the protein bar. In response to the further selection, the display characteristics can be adjusted such that he selected point on the protein bar is made the center point.

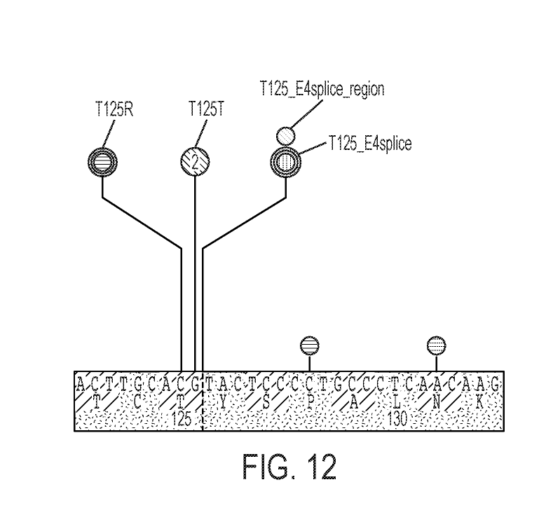

In an aspect, the selected portion of the protein bar can be shown at a nucleotide resolution. In particular, FIG. 12 shows an example of an enhanced view 1200 of a selected portion of a protein bar. In an aspect, the enhanced view 1200 can display features of the protein bar at nucleotide resolution. In particular, the selected portion of the protein bar can be shown in additional detail, such that each nucleotide that makes up an amino acid along the protein bar is represented. Accordingly, mutations corresponding to a particular nucleotide within an amino acid are shown with a corresponding alignment indicator indicating a particular amino acid at which the mutation is present. Moreover, where mutations are not linked to a particular nucleotide, an alignment indicator can indicate that the mutation occurs between two nucleotides. As an example, an alignment indicator can show that a mutation occurs at an intron (e.g., an area between two amino acids in a protein) by connecting the graphical representation to an exon junction (e.g., a point where two amino acids (exons) meet on the protein bar).

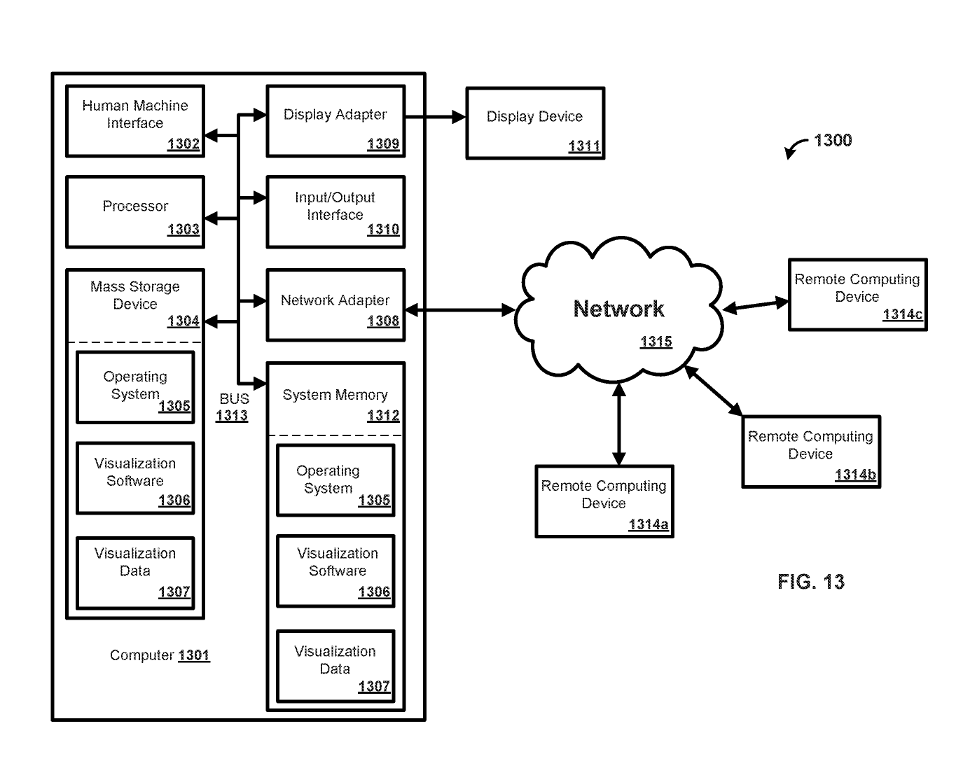

In an exemplary aspect, the methods and systems can be implemented on a computer 1301 as illustrated in FIG. 13 and described below. The methods and systems disclosed can utilize one or more computers to perform one or more functions in one or more locations. FIG. 13 is a block diagram illustrating an exemplary operating environment 1300 for performing the disclosed methods. This exemplary operating environment 1300 is only an example of an operating environment and is not intended to suggest any limitation as to the scope of use or functionality of operating environment architecture. Neither should the operating environment 1300 be interpreted as having any dependency or requirement relating to any one or combination of components illustrated in the exemplary operating environment 1300.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1301. The computer 1301 can comprise one or more components, such as one or more processors 1303, a system memory 1312, and a bus 1313 that couples various components of the computer 1301 including the one or more processors 1303 to the system memory 1312. In the case of multiple processors 1303, the system can utilize parallel computing.

The bus 1313 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1313, and all buses specified in this description can also be implemented over a wired or wireless network connection and one or more of the components of the computer 1301, such as the one or more processors 1303, a mass storage device 1304, an operating system 1305, visualization software 1306, visualization data 1307, a network adapter 1308, system memory 1312, an Input/Output Interface 1310, a display adapter 1309, a display device 1311, and a human machine interface 1302, can be contained within one or more remote computing devices 1314a,b,c at physically separate locations, connected through buses of this form, in effect implementing a fully distributed system.

The computer 1301 typically comprises a variety of computer readable media. Exemplary readable media can be any available media that is accessible by the computer 1301 and comprises, for example and not meant to be limiting, both volatile and non-volatile media, removable and non-removable media. The system memory 1312 can comprise computer readable media in the form of volatile memory, such as random access memory (RAM), and/or non-volatile memory, such as read only memory (ROM). The system memory 1312 typically can comprise data such as visualization data 1307 and/or program modules such as operating system 1305 and visualization software 1306 that are accessible to and/or are operated on by the one or more processors 1303.

In another aspect, the computer 1301 can also comprise other removable/non-removable, volatile/non-volatile computer storage media. The mass storage device 1304 can provide non-volatile storage of computer code, computer readable instructions, data structures, program modules, and other data for the computer 1301. For example, a mass storage device 1304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1304, including by way of example, an operating system 1305 and visualization software 1306. One or more of the operating system 1305 and visualization software 1306 (or some combination thereof) can comprise elements of the programming and the visualization software 1306. Visualization data 1307 can also be stored on the mass storage device 1304. Visualization data 1307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1315.

In another aspect, the user can enter commands and information into the computer 1301 via an input device. Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1303 via a human machine interface 1302 that is coupled to the bus 1313, but can be connected by other interface and bus structures, such as a parallel port, game port, an IEEE 1394 Port (also known as a Firewire port), a serial port, network adapter 1308, and/or a universal serial bus (USB).

In yet another aspect, a display device 1311 can also be connected to the bus 1313 via an interface, such as a display adapter 1309. It is contemplated that the computer 1301 can have more than one display adapter 1309 and the computer 1301 can have more than one display device 1311. For example, a display device 1311 can be a monitor, an LCD (Liquid Crystal Display), light emitting diode (LED) display, television, smart lens, smart glass, and/or a projector. In addition to the display device 1311, other output peripheral devices can comprise components such as speakers (not shown) and a printer (not shown) which can be connected to the computer 1301 via Input/Output Interface 1310. Any step and/or result of the methods can be output in any form to an output device. Such output can be any form of visual representation, including, but not limited to, textual, graphical, animation, audio, tactile, and the like. The display 1311 and computer 1301 can be part of one device, or separate devices.

The computer 1301 can operate in a networked environment using logical connections to one or more remote computing devices 1314a,b,c. By way of example, a remote computing device 1314a,b,c can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1301 and a remote computing device 1314a,b,c can be made via a network 1315, such as a local area network (LAN) and/or a general wide area network (WAN). Such network connections can be through a network adapter 1308. A network adapter 1308 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1305 are illustrated herein as discrete blocks, although it is recognized that such programs and components can reside at various times in different storage components of the computing device 1301, and are executed by the one or more processors 1303 of the computer 1301. An implementation of visualization software 1306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, at a computer, amino acid sequence data indicating an amino acid sequence of a protein;
receiving, at the computer, mutation information regarding one or more mutations in the amino acid sequence;
sorting the one or more mutations according to a corresponding position of the one or more mutations in the amino acid sequence;
determining, for each of the one or more mutations, one or more mutation characteristics;
setting, for each of the one or more mutations, a display position, wherein the display position comprises a horizontal position and a vertical position; and
displaying a graphical representation of all of the one or more mutations, wherein all of the one or more mutations are arranged based on the set display positions, and wherein an alignment position marker connects the display position to a marker indicating the position of the mutation.

2. The method of claim 1, wherein the horizontal position is set based on the position of the mutated amino acid in the amino acid sequence and a presence of mutations proximate to the position of the mutated amino acid, and wherein the vertical position is set based on a number of mutation variants at the position of the mutated amino acid.

3. The method of claim 2, wherein the determined one or more mutations are selected based on a mutation count of an amino acid in the amino acid sequence exceeding a predetermined threshold.

4. The method of claim 2, wherein displaying the graphical representation of all of the one or more mutations comprises displaying the one or more mutation characteristics associated with all of the one or more mutations.

5. The method of claim 1, wherein the one or more mutation characteristics comprise one or more of a mutation class, an indicator of an original amino acid, an indicator of the position of the mutated amino acid, an indicator of a mutation variant, a mutation count, an indication of whether the mutation is a germline mutation, and an indication of whether the mutation is a relapse mutation.

6. The method of claim 5, wherein the determined one or more mutations are selected based on a mutation count of an amino acid in the amino acid sequence not exceeding a predetermined threshold.

7. The method of claim 1, wherein the mutation characteristics comprise a mutation count, and wherein a size of the graphical representation is based on the mutation count.

8. The method of claim 1, wherein the horizontal position is selected based on the position of the mutated amino acid in the amino acid sequence, and wherein the vertical position is based on a sum of all mutations at the position of the mutated amino acid.

9. The method of claim 8, wherein the mutation characteristics comprise a mutation count, and wherein a size of the graphical representation is based on the mutation count.

10. The method of claim 9, wherein the display position is a center point of the graphical representation, and wherein all graphical representations having a same center point are arranged based on size.

11. A method comprising:
receiving, at a computer, amino acid sequence data indicating an amino acid sequence of a protein, the amino acid sequence data comprising a plurality of data points;
setting, for each of the plurality of data points, a display position, wherein a horizontal component of the display position is set based on an expression value and wherein the plurality of data points are arranged vertically in order of expression values; and
displaying the received amino acid sequence data based on the set display positions.

12. The method of claim 11, further comprising displaying a boxplot based on a selected subset of amino acid sequence data.

13. The method of claim 12, wherein the amino acid sequence data further comprises metadata indicating sample groups, and wherein the selected subset of amino acid data is based on the metadata.

14. The method of claim 11, further comprising:
receiving a selection indicating a range of expression value; and
displaying a hierarchical chart showing composition of data points in the selected range.

15. A method comprising:
receiving, at a computing device, amino acid sequence data indicating an amino acid sequence of a protein;
receiving, at the computer, mutation information indicating one or more mutations in the amino acid sequence;
sorting the one or more mutations according to a position of the one or more mutations in the amino acid sequence;
displaying a protein bar representing the protein along a first axis;
displaying the received amino acid sequence data graphically along the protein bar as one or more graphical representations;
receiving an indication from a user; and
adjusting one or more display characteristics in response to the indication.

16. The method of claim 15, wherein the indication comprises selection of one of the one or more graphical representations, and wherein adjusting the one or more display characteristics in response to the indication comprises alternating between a first and second view of the selected one of the one or more graphical representations.

17. The method of claim 15, wherein the indication comprises selection of a portion of the protein bar, and wherein adjusting the one or more display characteristics in response to the indication comprises adjusting a field of a display such that only the selected portion of the protein bar is visible.

18. The method of claim 17, further comprising receiving a second indication from the user comprising an instruction to revert to previous display characteristics, and wherein in response to the second indication, the one or more display characteristics revert.

19. The method of claim 17, further comprising receiving a second indication from the user selecting a particular point on the protein bar, and wherein in response to the second indication, the one or more display characteristics are adjusted such that the selected particular point on the protein bar is moved to a center of a display.

20. The method of claim 15, wherein the first axis is a horizontal axis.
